(19) United States
(12) Patent Application Publication
(10) Pub. No.: US 2015/0200904 A1
(43) Pub. Date: Jul. 16, 2015

(54) COMMUNICATING VIA A VIRTUAL COMMUNITY USING OUTSIDE CONTACT INFORMATION

(71) Applicant: Cellco Partnership d/b/a Verizon Wireless, Basking Ridge, NJ (US)

(72) Inventors: Radhika KHANNA, Danville, CA (US); Mahendra Tharshanan, San Ramon, CA (US)

(73) Assignee: Cellco Partnership d/b/a Verizon Wireless, Basking Ridge, NJ (US)

(21) Appl. No.: 14/153,671

(22) Filed: Jan. 13, 2014

(51) Int. Cl. H04L 12/58; H04W 4/12

(52) U.S. Cl. CPC H04L 51/32; H04W 4/12

(57) ABSTRACT

A device is provided that creates an account for a first member of a virtual community. The account includes a contact identifier used for communicating with the first member outside of the virtual community. The device receives a message via the virtual community from a second member of the virtual community. A recipient of the message being selected by the second member using outside contact information for a contact, and the outside contact information corresponding to contact information used to communicate with the contact outside of the virtual community. Additionally, the device identifies the first member of the virtual community as the recipient of the message based on the contact identifier included in the account and the outside contact information indicated by the message. Furthermore, the device transmits the message to the first member via the virtual community.

### BACKGROUND

New virtual communities are frequently created. Becoming a member of a new virtual community generally requires a person to create a new identify for the community. The user may distribute the new identity to other members of the virtual community. Likewise, other members may distribute their identity for the virtual community to the user. Thus, the members of the virtual community may communicate with each other using the new identities created for the virtual community.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of a device that corresponds to one or more devices of FIG. 2;

FIG. 4 is a flowchart of an example process for registering a user as a member of a virtual community;

FIG. 5 is a diagram of an example account data structure for an account related to the process shown in FIG. 4;

FIG. 6 is a flowchart of an example process for determining contacts of the user that are members of the virtual community;

FIG. 7 is a diagram of an example account data structure storing contact information for contacts of the user related to the process shown in FIG. 6;

FIG. 8 is a flowchart of an example process of sending a message via the virtual community; and

FIG. 9 is a diagram of an example implementation relating to the example process shown in FIG. 8.

### DETAILED DESCRIPTION OF PREFERRED EMBODIMENTS

The following detailed description of example implementations refers to the accompanying drawings. The same reference numbers in different drawings may identify the same or similar elements.

Joining a new virtual network may be burdensome for a person. For example, not only may a person be required to create a new identity, the person may also have to acquire new contact information related to a new identity for a friend in the virtual community to communicate in the virtual community. Accordingly, the friend's contact information in the virtual community may be one more pieces of contact information the person has to manage for the friend in addition to other kinds of contact information for the friend (e.g., a phone number, an email address, etc.). Implementations described herein may allow a person to join a virtual community and contact a friend via the virtual community using outside contact information used for contacting the friend outside of the virtual community instead of using contact information unique to the virtual community.

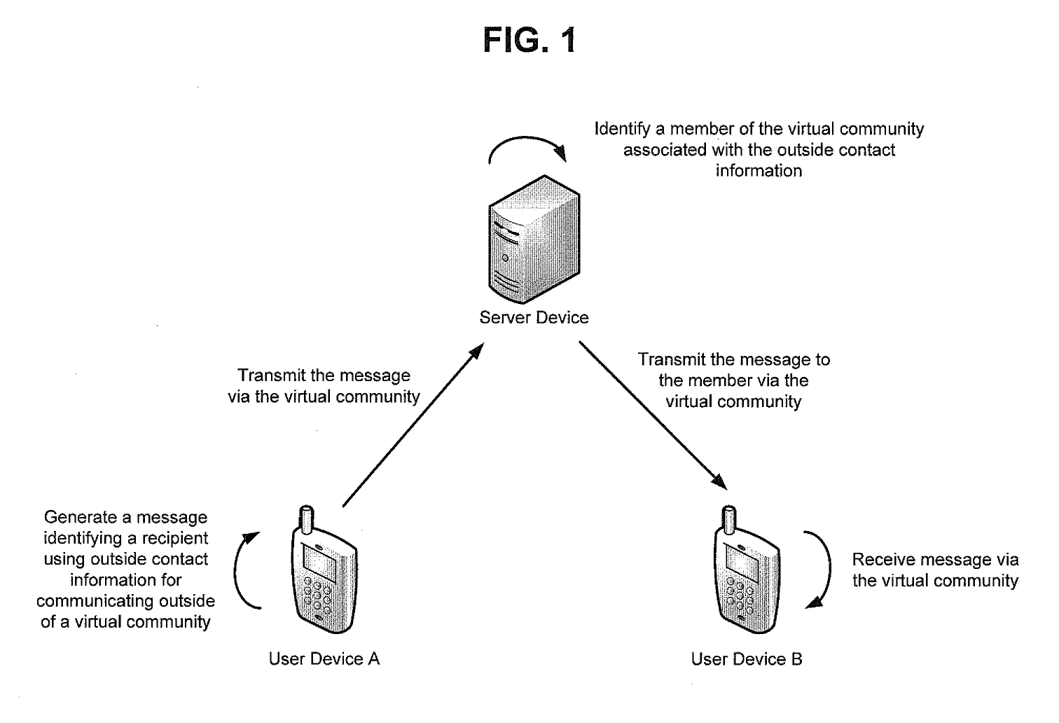

FIG. 1 is a diagram of an overview of an example implementation 100 described herein.

Assume user device A executes a communication application for communicating via a virtual community. A first member of the virtual community may log into the communication application on user device A to generate a message. The first member may identify a recipient of the message using outside contact information that identifies contact information for communicating outside of the virtual community (e.g., a phone number, an email address, etc.). User device A may transmit the message using the communication application to a server device via the virtual community.

Assume the server device stores an account for each member of the virtual community. An account may identify outside contact information for a member. Accordingly, when the server device receives the message from user device A, the server device may identify an account for a second member associated with the outside contact information identified in the message. In other words, the server device may determine that a recipient of the message is the second member of the virtual community based on the outside contact information in the message matching the outside contact information in the second member's account.

Further, assume user device B executes the communication application for communicating via the virtual community. The second member may use user device B, or any other device with the communication application installed, to log into the virtual community. The server device may transmit the message from the first member to user device B for the second member.

In this way, the first member of the virtual community may send a message to the second member of the virtual community using outside contact information. Thus, the first member may avoid having to manage contact information for the second member unique to the virtual community (e.g., a new username, a new phone number, etc.) and still use the virtual community to communicate with the second member. Put differently, a person may use a virtual community to communicate with contacts of the person without having to exchange contact information unique to the virtual community.

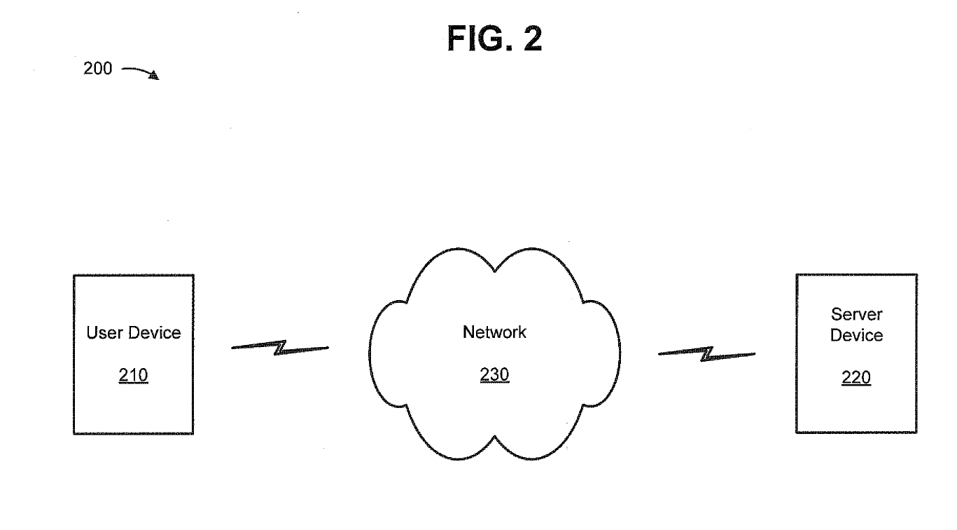

FIG. 2 is a diagram of an example environment 200 in which systems and/or methods described herein may be implemented. As shown in FIG. 2, environment 200 may include user device 210, server device 220, and/or network 230.

User device 210 may include a device capable of receiving and providing information. For example, user device 210 may include a mobile phone (e.g., a smart phone, a radiotelephone, etc.), a computing device (e.g., a desktop computer, a laptop computer, a tablet computer, a handheld computer, a camera, an audio recorder, a camcorder, etc.), or a similar device. In some implementations, user device 210 may include a communication interface that allows user device 210 to receive information from and/or transmit information to server device 220 and/or another device in environment 200. Additionally, or alternatively, user device 210 may have a communication application installed for accessing and communicating over a virtual community.

Server device 220 may include one or more devices capable of processing and/or routing information. In some implementations, server device 220 may include a communication interface that allows server device 220 to receive information from and/or transmit information to other devices in environment 200. In some implementations, server device 230 may manage a virtual community.

Network 230 may include one or more wired and/or wireless networks. For example, network 240 may include a cellular network, a public land mobile network (“PLMN”), a second generation (“2G”) network, a third generation (“3G”) network, a fourth generation (“4G”) network, a fifth generation (“5G”) network, a long term evolution (“LTE”) network, and/or a similar type of network. Additionally, or alternatively, network 270 may include a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

The number of devices and/or networks shown in FIG. 2 is provided for explanatory purposes. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200. Devices of environment 200 may interconnect via wired connections, wireless connections, or a combination of wired and wireless connections.

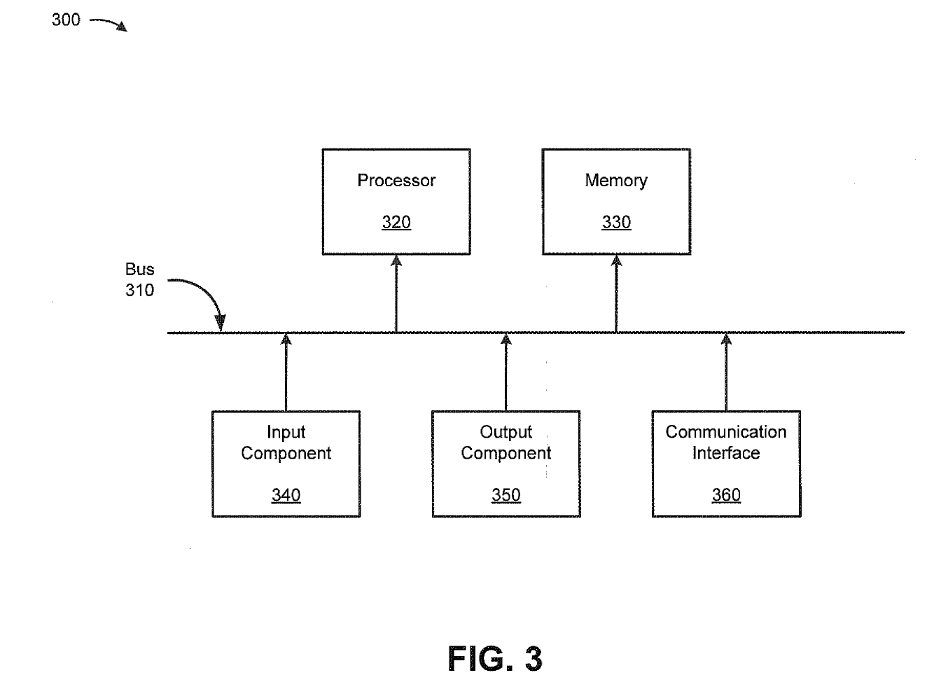

FIG. 3 is a diagram of example components of a device 300. Device 300 may correspond to user device 210 and/or server device 220. Additionally, or alternatively, user device 210 and/or server device 220 may include one or more devices 300 and/or one or more components of device 300.

As illustrated in FIG. 3, device 300 may include a bus 310, a processor 320, a memory 330, an input component 340, an output component 350, and/or a communication interface 360.

Bus 310 may include a path that permits communication among the components of device 300. Processor 320 may include a processor (e.g., a central processing unit, a graphics processing unit, an accelerated processing unit), a microprocessor, and/or another type of processing component (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.).

Output component 350 may include a component that outputs information from device 300 (e.g., a display, a speaker, one or more light-emitting diodes (“LEDs”), etc.).

Communication interface 360 may include a transceiver-like component, such as a transceiver and/or a separate receiver and transmitter that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium is defined as a non-transitory memory device. A memory device includes memory space within a single storage device or memory space spread across multiple storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

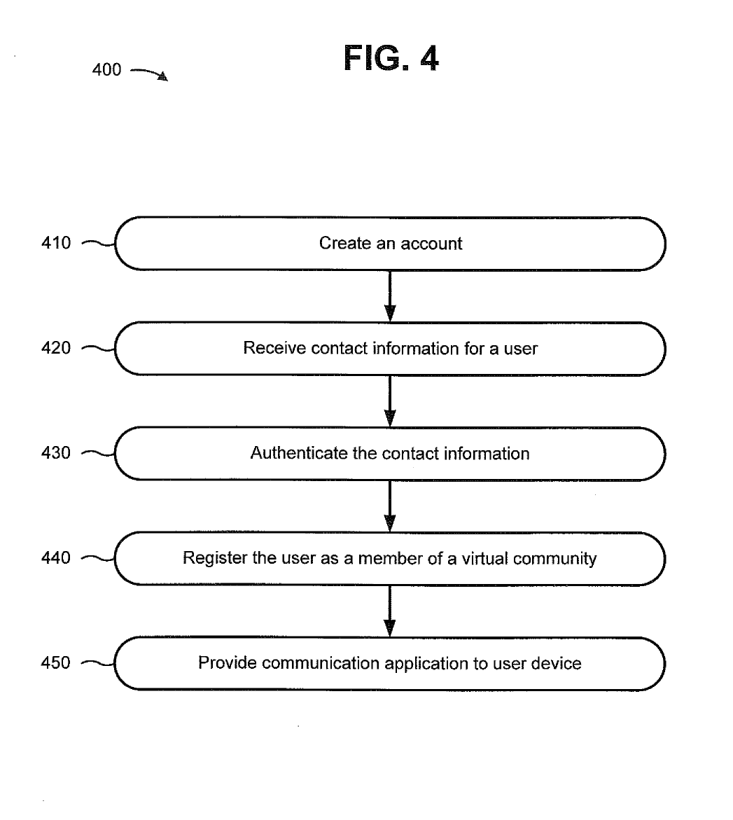

FIG. 4 is a flowchart of an example process 400 for registering a user as a member of a virtual community. In some implementations, one or more process blocks of FIG. 4 may be performed by server device 220. Additionally, or alternatively, one or more process blocks of FIG. 4 may be performed by another device or a group of devices separate from or including server device 220.

As shown in FIG. 4, process 400 may include creating an account (block 410). For example, server device 220 may create the account for a virtual community.

In some implementations, the virtual community may be operated and managed by a network operator. For example, the network operator may control server device 220. The network operator may be a mobile network operator, a wireless service provider, and/or a phone company. In some implementations, the virtual community may be operated by an operator separate from a network operator.

The virtual community may be a social network of members that interact using a communication application. The communication application may be installed on user device 210 and/or may be a web based application executed by user device 210. The virtual community may include multiple members each having an account. The account for each member may include contact information for the member. The members of the virtual community may communicate with each other via server device 220 using the communication application.

In some implementations, a user may use user device 210 or another device to send a request to create the account to server device 220. The user may be a subscriber of the network operator or non-subscriber of the network operator. A subscriber of the network operator may have a phone number (e.g., a mobile phone number) provided by the network operator for use outside of the virtual community, and a non-subscriber may not have a phone number provided by the network operator. Server device 220 may receive the request and create the account by generating an entry in a data structure for the account.

The account may include an account identifier that identifies the account. For example, server device 220 may generate the account identifier. The account may also include a username and password the user uses to log into the account. For example, the user may select a username and password, and input the username and the password into user device 210. In some implementations, the username may be the same as a contact identifier (e.g., a phone number, an email address, etc.). Additionally, or alternatively, the username may be a string of characters input by the user into user device 210. User device 210 may transmit the username and the password to server device 220. Server device 220 may store the username and password in connection with the account in the data structure.

In some implementations, server device 220 may create the account independent of a request from a user. For example, the user may subscribe to a mobile operating network and have a phone number provided by the mobile operating network. The network operator may send a request to server device 220 to create the account for the user of the phone number, and server device 220 may create the account by generating an entry in the data structure. The network operator may also provide a username and password to the server device 220 for the account. For example, the user may already have an account including a username and a password with the network operator. Accordingly, the same username and the same password may be used by server device 220. Additionally, or alternatively, the network operator may operate and/or control server device 220 and use server device 220 to create the account.

Server device 220 may create multiple accounts for multiple members and may generate an entry in the data structure for each account. The data structure may be stored in a memory of server device 220 and/or in another device that may communicate with server device 220.

As further shown in FIG. 4, process 400 may include receiving contact information for the user (block 420). For example, server device 220 may receive the contact information for the user.

In some implementations, the user may use user device 210 to input the contact information. User device 210 may transmit the contact information to server device 220 and server device 220 may receive the contact information. Additionally, or alternatively, user device 210 may obtain the contact information from a memory in user device 210 and transmit the contact information to server device 220. In some implementations, another device may provide the contact information for the user to server device 220. For example, a network operator may provide contact information for a subscriber to server device 220.

The contact information may include a contact identifier used for contacting a person. For example, the contact identifier may include a phone number, an email address, an instant message (IM) address, a username (e.g., a username for an Internet based application or service), and/or a facsimile (fax) machine number. The contact information may include multiple contact identifiers of the same kind (e.g., more than one phone number) and/or multiple kinds of contact identifiers (e.g., a phone number and an email address). For example, the contact information may include multiple phone numbers (e.g., a cell phone number, a work phone number, a home phone number, etc.) and/or multiple email address (e.g., a personal email, a work email, etc.).

The contact identifier may be a phone number issued to a subscriber by the network operator. For example, a subscriber may use the issued phone number as the contact identifier. Additionally, or alternatively, the contact identifier may be issued to the user independent of the network operator. For example, a non-subscriber may use a phone number issued by a different network operator as the contact identifier. Additionally, or alternatively, a subscriber and/or a non-subscriber may use an email address, an instant message (IM) address, a username (e.g., a username for an Internet based application or service), and/or a facsimile (fax) machine number as the contact identifier.

Server device 220 may store the contact information in the data structure for the account.

As further shown in FIG. 4, process 400 may include authenticating the contact information (block 430). For example, server device 220 may authenticate the contact information.

To authenticate the contact information, server device 220 may send a message to a contact identifier included in the contact information used for communicating outside of the virtual community. The message may include authentication information used to verify the user actually uses the contact information. The authentication information may include a password, a number, and/or an internet address.

For example, to authenticate a mobile phone number, server device 220 may send a message (e.g., a short message service (SMS) message and/or a multimedia messaging service (MMS) message) to the mobile phone number. A user may reply to the message to authenticate the mobile phone number. Additionally, or alternatively, the message may include a password. The user may input the password from the message into user device 210 and transmit the authentication information to server device 220. Server device 220 may authenticate the mobile phone number by checking that the password received from user device 210 matches the authentication information included in the message sent to the mobile phone number. In some implementations, a mobile phone number may be authenticated by a network operator that operates the virtual community without contacting the mobile phone number. For example, the network operator may have provided the mobile phone number to the user and automatically authenticate the mobile phone number as being associated with the user.

In some implementations, to authenticate a phone number, server device 220 may call the phone number and provide the authentication information. For example, server device 220 may initiate an automated phone call to the phone number and leave an audio message and/or recording including the authentication information. The user may input the authentication information from the audio message or the recording into user device 210 and transmit the authentication information to server device 220. Server device 220 may authenticate the phone number by checking that the authentication information received from user device 210 matches the authentication information included in the call to the phone number.

In some implementations, to authenticate an email address, server device 220 may send an email to the email address. A user may reply to the email to authenticate the email address. Additionally, or alternatively, the email may include authentication information. For example, the authentication information may be an Internet address or a link to a website that the user may visit to authenticate the email address. Additionally, or alternatively, the authentication information may include a password. The user may input the password from the email into user device 210 and transmit the password to server device 220. Server device 220 may authenticate the email address by checking that the password received from user device 210 matches the password included in the email sent to the email address.

In some implementations, to authenticate an IM address and/or a username, server device 220 may send a message to the IM address and/or the username using a corresponding application or service. For example, if the username is a username for an online social network, server device 220 may send the username a message using the online social network. A user may reply to the message to authenticate the IM address and/or the username. Additionally, or alternatively, the message may include authentication information. For example, the authentication information may be an Internet address or a link to a website that the user may visit to authenticate the IM address and/or the username. Additionally, or alternatively, the authentication information may include a password. The user may input the password from the message into user device 210 and transmit the password to server device 220. Server device 220 may authenticate the IM address and/or the username by checking that the password received from user device 210 matches the password included in the message sent to the IM address and/or the username.

In some implementations, to authenticate a fax number, server device 220 may send a fax including a password to the fax number. The user may input the password from the fax into user device 210 and transmit the password to server device 220. Server device 220 may authenticate the fax by checking that the password received from user device 210 matches the password included in the fax sent to the fax number.

Server device 220 may store the authenticated contact information in the data structure for the account.

As further shown in FIG. 4, process 400 may include registering the user as a member of the virtual community (block 440). For example, server device 220 may register the user as a member of the virtual community.

To register the user as a member, server device 220 may add the user to a closed authentication group stored in the data structure. Additionally, or alternatively, server device 220 may add information to the account for the user indicating that the user is a member of the virtual community. A subscriber and/or a non-subscriber to the network operator may be registered as a member of the virtual community managed by the network operator.

As further shown in FIG. 4, process 400 may include providing the communication application to user device 210 (block 450). For example, server device 220 may provide the communication application to user device 210. To provide the communication application, server device 220 may transmit the communication application to user device 210 over network 230. Additionally, or alternatively, server device 220 may provide the communication application to another device from which user device 210 may download the application. For example, server device 220 may provide the communication application to a server hosting an online application store. User device 210 may receive and install the communication application from the online application store.

In some implementations, the communication application may be a web application executed through an Internet browser. Accordingly, server device 220 may provide the communication application to user device 210 by user device 210 connecting to server device 220 through an internet browser. User device 210 may execute the communication application by accessing the communication application, via the Internet browser, on server device 220.

A member of the virtual community using the communication application may communicate with another member using the communication application. For example, a member may input a message using the communication application and user device 210 may transmit the message to server device 220. Server device 220 may transmit the message to another member executing the communication application on a different user device 210.

Each member of the community may be associated with outside contact information. Outside contact information may be contact information used for communicating outside of the virtual community and/or the communication application (e.g., a phone number, an email address, a fax number, etc.). In other words, outside contact information may be used outside of and independent of the virtual community to communicate using other communication methods. For example, each member may be associated with outside contact information received at block 420 and authenticated at block 430. However, server device 220 may not provide the members with contact information unique to the communication application or the virtual community. Instead, members use the outside contact information to send and receive messages using the communication application rather than using contact information unique to the communication application.

For example, a first member may be associated with a home phone number (i.e., outside contact information). A second member may send the first member a message using the communication application by inputting the first member's home phone number into the communication application. The first member would receive the message on user device 210 executing the communication application, and not on the home phone.

In some implementations, a member that is a subscriber of a network operator that controls server device 220 may use the communication application to send text messages (e.g., SMS messages and/or MMS messages) to a phone number not associated with a member of the virtual community. For example, the subscriber may execute the communication application on a desktop computer and send a text message to a mobile phone number using the network operator's network. Server device 220 may cause a text message to be sent to a mobile phone associated with the mobile phone number using a standard text message application. The network operator may charge the subscriber for the text message according to a contract or text message plan the subscriber has with the network operator.

Additionally, or alternatively, a member that is a non-subscriber of a network operator that controls server device 220 may use the communication application to send text messages to a phone number not associated with a member of the virtual community. The network operator and/or server device 220 may charge the non-subscriber for the text messages sent using the network operator's network.

While a series of blocks has been described with regard to FIG. 4, the blocks and/or the order of the blocks may be modified in some implementations. For example, providing the communication application (block 450) may be performed before receiving the contact information for a user (block 420). The user may use the communication application on user device 210 to input the contact information and transmit the contact information to server device 220. Additionally, or alternatively, non-dependent blocks may be performed in parallel.

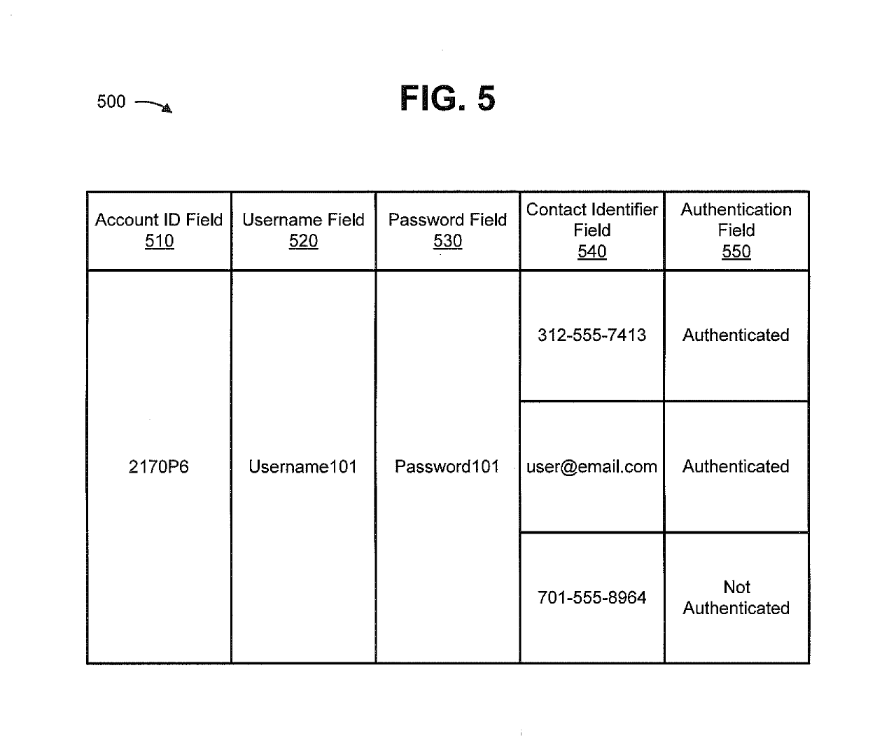

FIG. 5 is a diagram of an example account data structure 500 for an account related to process 400 shown in FIG. 4. Account data structure 500 may include an account ID field 510, a username field 520, a password field 530, a contact identifier field 540, and an authentication field 550.

Account ID field 510 may include an account identifier that identifies the account. For example, account ID field 510 may include an account identifier “2170P6” as shown in FIG. 5.

Username field 520 may include a username the user uses to log into the virtual community. For example, username field 520 may include the username “Username 101” as shown in FIG. 5.

Password field 530 may include a password the user uses to log into the virtual community. For example, password field 530 may include the password “Password101” as shown in FIG. 5.

Contact identifier field 540 may include contact identifiers that the user associated with the account identified in account ID field 510. The contact identifiers may be outside contact information used to communicate with the user outside of the virtual community. For example, contact identifier field 540 may include a home phone number “312-555-7413” for the user, an email address “user@email.com” for the user, and a mobile phone number “701-555-8964” for the user, as shown in FIG. 5.

Authentication field 550 may include information indicating whether an associated contact identifier has been authenticated. Additionally, or alternatively, the authenticated contact identifiers may be used by other members of the virtual community to communicate with the user via the virtual community. For example, authentication field 550 may include information indicating a contact identifier is “Authenticated” or “Not Authenticated.”

Account data structure 500 may include additional fields than those shown in FIG. 5, fewer fields than those shown in FIG. 5, and/or different fields than those shown in FIG. 5.

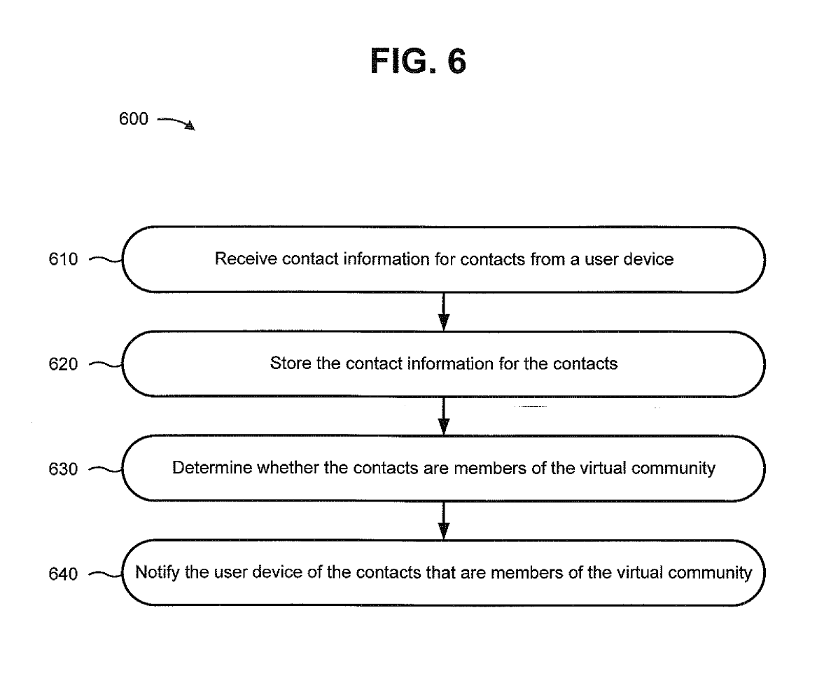

FIG. 6 is a flowchart of an example process 600 for determining contacts that are members of the virtual community. In some implementations, one or more process blocks of FIG. 6 may be performed by server device 220. Additionally, or alternatively, one or more process blocks of FIG. 6 may be performed by another device or a group of devices separate from or including server device 220.

As shown in FIG. 6, process 600 may include receiving contact information for contacts from user device 210 (block 610). For example, server device 220 may receive the contact information for the contacts from user device 210 executing the communication application.

User device 210 may store the contact information for the contacts in a memory using an address book, a contacts list, and/or another application that stores contact information for the contacts.

The user may log into the virtual community using the communication application on user device 210. For example, the user may input a username and a password to the communication application. User device 210 may provide the username and password to server device 220 for authentication. Server device 220 may authenticate the user by checking that the input password matches a password stored in the data structure associated with the username. Once the user has been authenticated, server device 220 identify an account for the user and may receive contact information for contacts from user device 210. Server device 220 may associate the contact information for the contacts with the user's account.

In some implementations, server device 220 may send user device 210, which is executing the communication application, a request for the contact information for the contacts. User device 210 may receive the request and obtain the contact information for the contacts from a memory in user device 210. User device 210 may send the contact information for the contacts to server device 220, and server device 220 may receive the contact information for the contacts.

Additionally, or alternatively, user device 210 may automatically send the contact information for the contacts to server device 220. For example, the communication application installed on user device 210 may obtain the contact information for the contacts each time user device 210 executes the communication application and logs into the virtual community. User device 210 may send the contact information for the contacts to server device 220, and server device 220 may receive the contact information for the contacts. Additionally, or alternatively, user device 210 may periodically send the contact information for the contacts to server device 220.

A user associated with an account may use more than one user device 210 to transmit contact information for contacts to server device 220. For example, the contacts identified on a user's mobile phone may be different than the contacts identified on a user's desktop computer. Both the user's mobile phone and the user's desktop computer may transmit contact information for contacts to server device 220. In other words, any user device 210 that executes the communication application may transmit contact information for contacts to server device 220. Accordingly, server device 220 may receive contact information for contacts of a same user from more than one user device 210.

Additionally, or alternatively, server device 220 may receive contact information for contacts of multiple users (e.g., members of the virtual community).

In some implementations, user device 210 may encrypt the contact information before sending the contact information to server device 220. For example, user device 210 may use an encryption function to create an encryption value for the contact information and transmit the encryption value as the contact information. Server device 220 may receive the encrypted contact information from user device 210. In some implementations, server device 220 may be unable to decrypt the encrypted contact information.

A contact may include a person, a business, and/or an organization. For example, the contact may be a person for which the user of user device 210 has contact information (e.g., a family member, a friend, a coworker, etc.). Additionally, or alternatively, the contact may be a business or organization for which the user of user device 210 has contact information (e.g., a restaurant, a store, etc.).

Contact information for a contact may include a contact name and a contact identifier used for contacting the contact. Each name may be associated with one or more contact identifiers.

The contact name may be any string of characters (e.g., letters, numbers, symbols, etc.) of any length. For example, the contact name may be “Husband,” “John Smith,” and/or “Pizza Place.” The contact name may be specified or selected by a user. For example, the user may choose a contact name when entering the contact information into an address book on user device 210.

The contact identifier may include a phone number, an email address, an IM address, a username (e.g., a username for an Internet based application or service), and/or a fax machine number for the contact. The contact information may include multiple contact identifiers of the same kind associated with a contact name (e.g., more than one phone number) and/or multiple kinds of contact identifiers (e.g., a phone number and an email address) associated with a contact name. For example, the contact information may include multiple phone numbers (e.g., a cell phone number, a work phone number, a home phone number, etc.) and/or multiple email addresses (e.g., personal email, work email, etc.) associated with a contact name.

As further shown in FIG. 6, process 600 may include storing the contact information for the contacts (block 620). For example, server device 220 may store the contact information for the contacts.

Server device 220 may store the contact information for the contacts of a user to be associated with the user's account. Accordingly, if the contact information for the contacts of the user is received from multiple user devices 210 associated with the user, all the contact information for contacts of the user may be associated with the user's account.

Server device 220 may update the stored contact information each time server device 220 receives contact information for a new contact for user device 210. Additionally, or alternatively, server device 220 may update the stored contact information if a name or a contact identifier for a stored contact changes.

Additionally, or alternatively, server device 220 may store contact information for contacts of multiple users (e.g., members of the virtual community).

Server device 220 may store the contact information for the contacts in a memory of server device 220 and/or another in another device.

In some implementations, server device 220 may receive encrypted contact information and store the encrypted contact information. In some implementations, server device 220 may not decrypt the encrypted contact information to reveal the contact information Accordingly, server device 220 may not have access to the actual content identifier and may only have access to the encrypted contact information.

As further shown in FIG. 6, process 600 may include determining whether the contacts are members of the virtual community (block 630). For example, server device 220 may determine whether the contacts are members of the virtual community.

Server device 220 may compare the contact identifiers for the contacts received from user device 210 with contact identifiers for members of the virtual community stored in the data structure. If a contact identifier (e.g., a phone number, an email address, etc.) for a contact from user device 210 matches a contact identifier for a member of the virtual community stored in the data structure, server device 220 may determine that the contact is a member of the virtual community. In some implementations, server device 220 may determine whether each contact of the user is a member of the virtual community. Additionally, or alternatively, server device 220 may compare encrypted values for the contact identifiers instead of comparing the actual contact identifiers.

Server device 220 may determine whether contacts are members when new contact information is received from user device 210. Additionally, or alternatively, server device 220 may determine whether a contact is a member when a new member is registered in the virtual community. For example, server device 220 may determine that a contact is not a member of the virtual community at a time the contact information for the contact is received from user device 210. Later, a member having a contact identifier included in the contact information for the contact may register in the virtual community. Accordingly, the contact of the user may be determined to be a member once the contact registers as a member in the virtual community.

As further shown in FIG. 6, process 600 may include notifying user device 210 of contacts that are members of the virtual community (block 640). For example, server device 220 may notify user device 210 of contacts that are members.

Server device 220 may notify user device 210 by sending a message to the communication application on user device 210 identifying which contacts are members of the virtual community. The communication application may display the names of contacts on user device 210 to inform the user of user device 210 which contacts are members of the virtual community. Accordingly, the user may be informed which contacts can be sent a message using the communication application.

The message sent by server device 220 may include a contact name and/or a contact identifier(s) for each contact that is determined to be a member. The contact name included in the message may be the contact name received from user device 210 at block 610. Thus, the user may easily identify the member using a known contact name. The contact identifier(s) for the contact included in the message may be the contact identifier(s) received from user device 210 at block 610 that match the contact identifier(s) for the member stored in the data structure. For example, if a contact is associated with a phone number and an email address, but only the phone number matches a content identifier for a member, the phone number may be provided in the notification from server 220 and not the email address. Accordingly, the communication application on user device 210 may only receive contact identifiers associated with members, and the communication application may use the contact identifiers in the message when sending messages to members.

In some implementations, the communication application may cause user device 210 to display the contact names, included in the contact information received at block 610, based on receiving the notification from server device 220. Accordingly, a user may be informed of a member of the virtual community using the contact name in the user's address book and/or a contact list stored on user device 210. For example, a first user may have a contact with a name “Husband.” A second user may have a contact with a name “John Smith.” However, “Husband” and “John Smith” may be the same person and have the same contact identifier (e.g., a same phone number). The first user may send a message to the member by executing the communication application on user device 210 to send a message to the contact “Husband.” Likewise, the second user may send a message to the same member by executing the communication application on user device 210 to send a message to the contact “John Smith.” In other words, the first user and the second user do not need a same contact name for a contact to send a message to the same member.

In some implementations, server device 220 may notify user device 210 of contacts that are members independent of the user device 210 from which the contact information was obtained. For example, a user may execute the communication application on a phone and a desktop computer. The phone may store contact information for a contact for which the desktop computer does not store contact information. However, the desktop computer may be notified that the contact from the phone is a member. For instance, server device 220 may send the desktop computer a notification including a name of the contact and/or a contact identifier for the contact. The desktop computer may store the contact name and/or the contact identifier. Accordingly, a user may use the desktop computer to send a message to the contact from the phone using the communication application executed by the desktop computer.

While a series of blocks has been described with regard to FIG. 6, the blocks and/or the order of the blocks may be modified in some implementations. Additionally, or alternatively, non-dependent blocks may be performed in parallel.

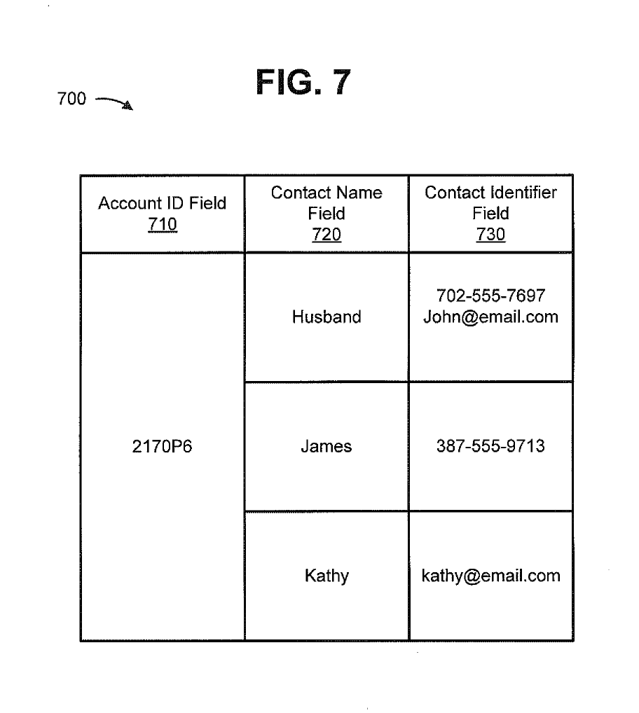

FIG. 7 is a diagram of an example account data structure 700 storing contact information for contacts of the user related to the process shown in FIG. 6. Account data structure 700 may include an account ID field 710, a contact name field 720, and/or a contact identifier field 730.

Account ID field 710 may include an account identifier that identifies the account. For example, account ID field 710 may include an account identifier “2170P6” as shown in FIG. 7.

Contact name field 720 may include a contact name for a contact. For example, contact name field 720 may include the contact name “Husband.”

Contact identifier field 730 may include a contact identifier for the contact. For example, contact identifier field 730 may include a phone number “702-555-7697” and an email address “John@email.com” for a contact. Contact identifier field 730 may be associated with contact name field 720, and each contact name may be associated with one or more contact identifiers.

Account data structure 700 may include additional fields than those shown in FIG. 7, fewer fields than those shown in FIG. 7, and/or different fields than those shown in FIG. 7. In some implementations, account data structure 700 may be added to account data structure 500 shown in FIG. 5.

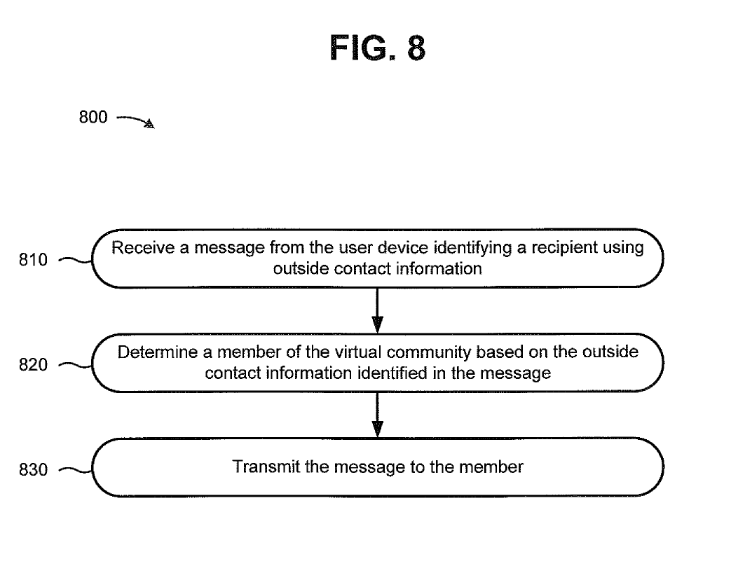

FIG. 8 is a flowchart of an example process 800 for sending a message via the virtual community. In some implementations, one or more process blocks of FIG. 8 may be performed by server device 220. Additionally, or alternatively, one or more process blocks of FIG. 8 may be performed by another device or a group of devices separate from or including server device 220.

As shown in FIG. 8, process 800 may include receiving a message from user device 210 identifying a recipient using outside contact information (block 810). For example, server device 220 may receive the message from user device 210 identifying the outside contact information.

A user may execute the communication application on user device 210 and log into the virtual community as a member by inputting a username and a password associated with the member's account.

A user may provide input to the communication application to create a message. For example, a user may use user device 210 to input content for the message using the communication application. The content may include any kind of data. For example, the content may include text, a file, and/or multimedia content.

A user of user device 210 may identify a recipient of the message by inputting contact information for a contact. For example, the user may input contact information by typing the contact information (e.g., a contact name and/or a contact identifier) into user device 210. Additionally, or alternatively, the communication application, via user device 210, may provide contact information for contacts of the user, that are members of the virtual community, from which to select. In other words, contact information for contacts that are not members of the virtual community may not be presented to the user to choose from as a recipient of the message. Thus, the user may input the contact information by selecting contact information presented to the use by the communication application.

In some implementations, the user may input a contact name as the contact information. For example, the user may select a contact name (e.g., “Husband”) without selecting a contact identifier for “Husband.” Additionally, or alternatively, the user may select a contact identifier as the contact information. For example, the user may select a contact identifier (e.g., a phone number, an email address, etc.) without selecting a contact name. Additionally, or alternatively, the user may input and/or select a contact name and a contact identifier as the contact information.

Once the user inputs the content of the message and identifies a recipient of the message using outside contact information, the communication application may create the message. The message may include the content and the contact information input by the user. The message may include a name of a contact and/or a contact identifier(s) for a contact. Additionally, or alternatively, the message may include information identifying the user of user device 210 (e.g., an account identifier, a contact identifier, etc.).

User device 210 may provide the message created by the communication application to server device 220 and server device 220 may receive the message. Server device 220 may store the message in a memory of server device 220 and/or another device.

As further shown in FIG. 8, process 800 may include determining a member of the virtual community based on the outside contact information identified in the message (block 820). For example, server device 220 may determine the member based on the outside contact information identified in the message.

In some implementations, the message received by server device 220 may include a contact name and information identifying a user of user device 210. Based on the information identifying the user (e.g., an account identifier), server device 220 may identify an account. Server device 220 may search the contact information, for the contacts associated with the account, for the contact name. Server device 220 may obtain a contact identifier associated with the name from the contact information for the contacts associated with the account. Accordingly, server device 220 may identify a member associated with the contact identifier by searching the data structure. For example, the message may include “Husband” as the contact name. Server device 220 may search the contact information for contacts associated with the user's account and identify a phone number for Husband. Server device 220 may use the phone number to identify a member of the virtual community registered using the phone number.

In some implementations, the message received by server device 220 may include a contact identifier for the contact. Accordingly, server device 220 may identify a member associated with the contact identifier by searching the data structure.

As further shown in FIG. 8, process 800 may include transmitting the message to the member (block 830). For example, server device 200 may transmit the message to the member.

The member may access the message from user device 210 by executing the communication application on user device 210. The member may log into the virtual community using the communication application on user device 210. For example, the member may input a username and a password into the communication application. User device 210 may provide the username and password to server device 220 for authentication. Server device 220 may authenticate the member by checking that the input password matches a password stored in the data structure associated with the username. Once the member has been authenticated, server device 200 may provide the message to the communication application on user device 210.

If the member is executing the communication application on user device 210 and logged into the virtual community when the message was received at block 810, server device 220 may transmit the message to the member's user device 210 in real time. Additionally, or alternatively, if the member is not executing the communication application on user device 210 when the message was received at block 810, server device 220 may provide the message to the member's user device 210 upon the member logging into the virtual community. Additionally, or alternatively, server device 220 may send or push a notification to the member's user device 210 indicating there is a message for the member.

Accordingly, the user may send a message to the member using the communication application by identifying outside contact information and without having to identify contact information unique to the communication application or the virtual community.

Server device 220 may store the message until the message has been sent to the member and/or for a predetermined time after the message has been sent to the recipient. For example, server device 220 may store messages received from a member and transmitted to the member so that the member may access these messages or conversations on multiple user devices 210. In other words, server device 220 may provide messages to the communication application on any user device 210 a member uses to access the virtual community. For example, assume a member exchanges messages via the virtual community on a phone. Later, if the member logs into the virtual community using a computer, server device 220 may transmit the stored messages to the computer so that the member can access past conversations on any device.

While a series of blocks has been described with regard to FIG. 8, the blocks and/or the order of the blocks may be modified in some implementations. Additionally, or alternatively, non-dependent blocks may be performed in parallel.

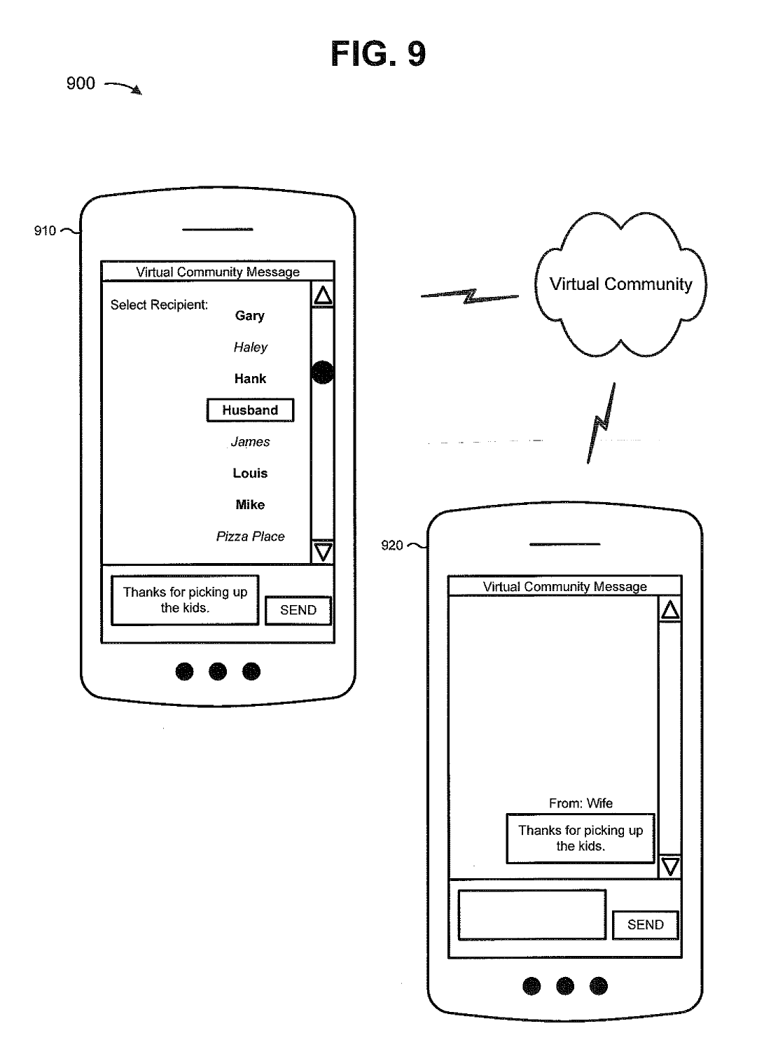

FIG. 9 is a diagram of an example implementation 900 relating to process 800 shown in FIG. 8. In example implementation 900, a user may send a text message to a member of the virtual community via the virtual community by selecting an outside contact name.

In example implementation 900, assume a user is registered as a member in a virtual community. Further, assume a server device stores an account for the user in the virtual community including outside contact information for contacts obtained from devices used by the user (e.g., a contact list from a phone, a computer, and/or a tablet). Also, assume the server device has determined which contacts are members of the virtual community.

A user device 910 executes a communication application and allows a user to generate a message. The server device may send contact information to user device 910 for contacts of the user that are members of the virtual community. The communication application may prompt the user to identify a recipient of the message and to enter content for the message. For example, the user may enter “Thanks for picking up the kids” as the content for the message

As shown in FIG. 9, the communication application may cause user device 910 to display a list of contact names from which the user can select. The contact names are names obtained from address books, contact lists, or the like on user devices used by the user. The list may distinguish between contacts that are members and contacts that are not members. For example, as shown in FIG. 9, contacts that are members may be displayed in a different color and/or font than contacts that are not members. Additionally, or alternatively, the list of contacts may only include members and not include non-members. A user may select a contact name from among the members of the virtual community (e.g., “Husband”) as a recipient of the message. User device 910 may send the message to the server device with the contact name “Husband” identified as the recipient. Accordingly, the user can use outside contact information to select a recipient of the message instead of having to identify contact information unique to the virtual community.

The server device may receive the message and search the stored outside contact information for contacts associated with the user's account, and identify a phone number associated with the contact “Husband.” Additionally, or alternatively, the message may include the phone number associated with “Husband” if the phone number was included in the contact information received by user device 910 from the server device. Accordingly, the server device may determine a member associated with the phone number and transmit the message to a user device 920 associated with the member via the virtual community.

In this way, the user may transmit a message to a member of the virtual community using outside contact information (e.g., a contact name “Husband”) rather than using contact information for the member unique to the virtual community.

Implementations described herein may allow a person to join a virtual community and contact friends in the virtual community using outside contact information instead of using contact information unique to the virtual community.

The foregoing disclosure provides illustration and description, but is not intended to be exhaustive or to limit the implementations to the precise form disclosed. Modifications and variations are possible in light of the above disclosure or may be acquired from practice of the implementations.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

As used herein, the term “component” is intended to be broadly construed as hardware, firmware, or a combination of hardware and software.

Some implementations are described herein in conjunction with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

Certain user interfaces have been described herein. In some implementations, the user interfaces may be customizable by a user or a device. Additionally, or alternatively, the user interfaces may be pre-configured to a standard configuration, a specific configuration based on a type of device on which the user interfaces are displayed, or a set of configurations based on capabilities and/or specifications associated with a device on which the user interfaces are displayed.

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and control hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
create an account for a first member of a virtual community,
the account including a contact identifier used for communicating with the first member outside of the virtual community;
receive a message via the virtual community from a second member of the virtual community,
a recipient of the message being selected by the second member using outside contact information for a contact,
the outside contact information corresponding to contact information used to communicate with the contact outside of the virtual community;
identify the first member of the virtual community as the recipient of the message based on the contact identifier included in the account and the outside contact information indicated by the message; and
transmit the message to the first member via the virtual community.

2. The device of claim 1, where the contact identifier includes at least one of a phone number, an email address, an instant message address, a username, or a facsimile number used to communicate outside of the virtual community.

3. The device of claim 1, where the one or more processors are further to:
receive a set of contact information for a plurality of contacts of the second member,
the plurality of contacts including the contact;
determine which of the plurality of contacts are members of the virtual community based on the set of contact information; and
provide a notification to the second member indicating which of the contacts of the second member are members of the virtual community,
the contact being identified as the recipient using information in the notification.

4. The device of claim 3, where the one or more processors, when receiving the set of contact information for the plurality of contacts, are further to:
receive the set of contact information for the plurality of contacts from a user device used by the second member to access the virtual community.

5. The device of claim 3, where the set of contact information for the plurality of contacts includes a respective contact name associated with a respective contact identifier for each of the plurality of contacts,
the respective contact name indicating a name selected by the second member, and
the respective contact identifier corresponding to a contact identifier used for communicating outside of the virtual community.

6. The device of claim 5, where the outside contact information identifies the contact as the recipient of the message using at least one of the respective contact name or the respective contact identifier.

7. The device of claim 5, where the outside contact information identifies the contact as the recipient of the message using the respective contact name without using the respective contact identifier.

8. The device of claim 5, where the one or more processors, when identifying the first member of the virtual community as the recipient of the message, are further to:
identify the respective contact identifier associated with the respective contact name identified by the outside contact information; and
determine that the respective contact identifier matches the contact identifier included in the account for the first member.

9. A computer-readable medium storing instructions, the instructions comprising:
a plurality of instructions that, when executed by a processor of a device, cause the processor to:
register a first member in a virtual community,
the first member being associated with a contact identifier used for communicating with the first member outside of the virtual community;
receive a message via the virtual community from a second member of the virtual community,
the message identifying a contact of the second member as a recipient of the message using outside contact information,
the outside contact information including information for contacting the contact outside of the virtual community;
determine the first member of the virtual community is the recipient of the message based on the contact identifier associated with the first member and the outside contact information indicated by the message; and
provide the message to the first member via the virtual community.

10. The computer-readable medium of claim 9, where the plurality of instructions, when registering the first member, further cause the processor to:
authenticate the contact identifier associated with the first member by contacting the first member outside of the virtual community using the contact identifier.

11. The computer-readable medium of claim 9, where the contact identifier includes a phone number, and
where the plurality of instructions, when authenticating the first member, further cause the processor to:
send, to the phone number, a text message including authentication information;
receive the authentication information from the first member; and
authenticate the phone number based on receiving the authentication information.

12. The computer-readable medium of claim 9, where the contact identifier includes a phone number, and
where the plurality of instructions, when authenticating the first member, further cause the processor to:
call the phone number and provide an audio message including authentication information;
receive the authentication information from the first member; and
authenticate the phone number based on receiving the authentication information.

13. The computer-readable medium of claim 9, where the contact identifier includes an email address, and
where the plurality of instructions, when authenticating the first member, further cause the processor to:
send, to the email address, an email including authentication information;
receive the authentication information from the first member; and
authenticate the email address based on receiving the authentication information.

14. The computer-readable medium of claim 9, where the plurality of instructions further cause the processor to:
provide a communication application to a user device associated with the second member,
the communication application being used by the second member to access the virtual community, and
the message being received from the user device executing the communication application.

15. A method, comprising:
managing, by a device, a virtual community including a first member and a second member;
storing, by the device, an account for the first member including a contact identifier used for communicating with the first member outside of the virtual community;
receiving, by the device, a message via the virtual community from the second member of the virtual community,
a recipient of the message being selected by the second member using outside contact information for a contact,
the outside contact information including information used to communicate with the contact outside of the virtual community;
identifying, by the device, the first member of the virtual community as the recipient of the message based on the contact identifier included in the account and the outside contact information indicated by the message; and
transmit the message to the first member via the virtual community.

16. The method of claim 15, where the virtual community is managed by a network operator that provides a network contact identifier to a subscriber for communication outside of the virtual community,
where the first member is a non-subscriber that is not provided with a network contact identifier by the network operator, and
where the second member is the subscriber.

17. The method of claim 16, where the account is a first account, the method further comprising:
storing a second account for the second member including the network contact identifier provided to the second member by the network operator.

18. The method of claim 15, further comprising:
storing contact information for the contacts of the first member,
the contact information identifying contacts that are members of the virtual community and non-members of the virtual community.

19. The method of claim 18, further comprising:
notify the first member when a non-member included in the contact information becomes a member of the virtual community.

20. The method of claim 15, further comprising:
receiving encrypted contact information for the contacts of the first member;
storing the encrypted contact information;
the device being unable to decrypt the encrypted contact information;
identifying the first member of the virtual community as the recipient of the message based on the encrypted contact information.
